(19) United States
(12) Patent Application Publication
(10) Pub. No.: US 2026/0371204 A1
(43) Pub. Date: Nov. 19, 2026

(54) PRIVATE CELLULAR NETWORK OFFLOADING FROM MOBILE NETWORK OPERATOR

(71) Applicant: AT&T Intellectual Property I, L.P., Atlanta, GA (US)

(72) Inventors: Yuxuan Jiang, Piscataway, NJ (US); Matti Hiltunen, Morristown, NJ (US); Gueyoung Jung, Belle Mead, NJ (US); Duong Thuy Anh Nguyen, Mesa, AZ (US)

(21) Appl. No.: 19/211,137

(22) Filed: May 16, 2025

(51) Int. Cl. H04W 36/30; H04L 41/16; H04L 43/087

(52) U.S. Cl. CPC H04W 36/30; H04L 41/16; H04L 43/087

(57) ABSTRACT

A processing system including at least one processor of a private cellular network may obtain a handover request for at least a first endpoint device from an open cellular network, wherein the handover request includes at least a first performance indicator metric associated with the open cellular network. The processing system may next generate an admission control decision via at least one machine learning model that is implemented by the processing system based upon at least one demand forecast associated with at least one endpoint device and may transmit to the open cellular network, the admission control decision. The processing system may then establish a data connection between the at least the first endpoint device and the private cellular network in accordance with the admission control decision.

Examples of the present disclosure relate to wireless communication networks, e.g., cellular networks and more particularly to methods, non-transitory computer-readable media, and apparatuses for generating a handover decision for offloading at least a first endpoint device to a private cellular network via at least one machine learning model implemented by a processing system of an open cellular network based upon at least one demand forecast associated with at least one endpoint device, and to methods, non-transitory computer-readable media, and apparatuses for generating an admission control decision for at least a first endpoint device from an open cellular network via at least one machine learning model implemented by a processing system of a private cellular network based upon at least one demand forecast associated with at least one endpoint device.

### BACKGROUND

radio access network (RAN) is part of the 3rdeneration Partnership Project (3GPP) fifth generation (5G) specifications for mobile networks. As part of the migration of cellular networks towards 5G, a RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Despite the success of 5G network deployments, Wi-Fi offloading remains a ubiquitous option for network operators to alleviate cellular network congestion and improve service quality. It involves directing mobile data traffic from cellular to Wi-Fi when possible to provide network congestion relief, enhanced indoor coverage, etc.

### SUMMARY

In one example, the present disclosure discloses a method, computer-readable medium, and apparatus for generating a handover decision for offloading at least a first endpoint device to a private cellular network via at least one machine learning model implemented by a processing system of an open cellular network based upon at least one demand forecast associated with at least one endpoint device. For example, a processing system including at least one processor of an open cellular network may determine that at least a first endpoint device is proximate to a coverage zone of a private cellular network. The processing system may next generate a handover decision via at least one machine learning model that is implemented by the processing system based upon at least one demand forecast associated with at least one endpoint device, where the handover decision is for offloading the at least the first endpoint device to the private cellular network. The processing system may then transmit a handover request to the private cellular network in accordance with the handover decision.

In one example, the present disclosure also discloses a method, computer-readable medium, and apparatus for generating an admission control decision for at least a first endpoint device from an open cellular network via at least one machine learning model implemented by a processing system of a private cellular network based upon at least one demand forecast associated with at least one endpoint device. For example, a processing system including at least one processor of a private cellular network may obtain a handover request for at least a first endpoint device from an open cellular network, wherein the handover request includes at least a first performance indicator metric associated with the open cellular network. The processing system may next generate an admission control decision via at least one machine learning model that is implemented by the processing system based upon at least one demand forecast associated with at least one endpoint device and may transmit to the open cellular network, the admission control decision. The processing system may then establish a data connection between the at least the first endpoint device and the private cellular network in accordance with the admission control decision.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example system of the present disclosure including mobile network operator (MNO) and private cellular network (PCN) radio access network (RAN) intelligent controllers (RICs);

FIG. 3 illustrates a flowchart of an example method for generating a handover decision for offloading at least a first endpoint device to a private cellular network via at least one machine learning model implemented by a processing system of an open cellular network based upon at least one demand forecast associated with at least one endpoint device;

FIG. 4 illustrates a flowchart of an example method for generating an admission control decision for at least a first endpoint device from an open cellular network via at least one machine learning model implemented by a processing system of a private cellular network based upon at least one demand forecast associated with at least one endpoint device; and

FIG. 5 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

Examples of the present disclosure include methods, non-transitory computer-readable media, and apparatuses for generating a handover decision for offloading at least a first endpoint device to a private cellular network via at least one machine learning model implemented by a processing system of an open cellular network based upon at least one demand forecast associated with at least one endpoint device. Examples of the present disclosure further include methods, non-transitory (i.e., tangible and/or physical) computer-readable media, and apparatuses for generating an admission control decision for at least a first endpoint device from an open cellular network via at least one machine learning model implemented by a processing system of a private cellular network based upon at least one demand forecast associated with at least one endpoint device. In particular, examples of the present disclosure provide an enhanced cellular communication system that intelligently and collaboratively offloads endpoint devices from a mobile network operator (MNO) network to a private cellular network (PCN). PCNs are increasingly being adopted by enterprises seeking enhanced security, reliability, and control over their connectivity infrastructure. In addition, many macro network operators, e.g., mobile network operators (MNOs), also referred to herein as “public cellular networks” or “open cellular networks,” are actively offering PCN solutions as commercial products, e.g., for enterprise customers. PCNs, or non-public networks as defined by 3rd Generation Partnership Project (3GPP), represent a specialized telecommunications deployment aimed at private entities such as enterprises, industries, or specific organizations, supporting critical applications such as internet of things (IoT) deployments, industrial automation, and sensitive data communications. Unlike MNOs, which serve the general public, PCNs are designed with specific technical and operational characteristics tailored to organizational needs. Currently, a PCN can be totally private (e.g., only allowing the users of the PCN) or can be part of one or more MNO networks by using a multi-operator core network (MOCN) technology that allows the PCN to connect to multiple packet cores.

Examples of the present disclosure leverage excess capacity of PCNs to provide additional coverage and service capabilities to MNOs, thereby reducing the need for extensive infrastructure investments. By incorporating advanced data-driven decision-making processes, including machine learning models and predictive analytics, the framework enables more intelligent handover procedures that consider a wide range of factors beyond mere signal strength. This approachnot only enhances the efficiency of network resource allocation but also improves the overall quality of service for end-users. Through this innovative framework, MNOs may rapidly extend effective network coverage, thus enhancing network performance and expanding service capabilities, and allowing the MNO to maintain (or increase) quality of service as experienced by the endpoint devices served by the MNO.

To further illustrate, examples of the present disclosure provide an efficient approach for expanding cellular services by utilizing the excess capacity of existing PCNs. Traditionally, increasing network capacity requires substantial infrastructure development. However, the present method allows for the enhancement of network capacity and quality of service (QoS) without extensive infrastructure changes. By strategically leveraging the surplus resources of PCNs, MNOs can extend their service capabilities in high-demand areas, such as airports and hospitals, and in transient environments like office parks and remote factories. This approach not only optimizes the use of existing infrastructure but also facilitates rapid deployment and scalability of services, thereby improving overall network performance and user experience.

Traditional handover procedures (e.g., as defined by 3GPP technical standards) may involve an endpoint device (e.g., user equipment (UE)) measuring signal strength to a serving cell and one or more neighboring cells operated by the same MNO. When these measurements fall below a predefined threshold, the serving eNodeB/gNodeB (NB) triggers a handover to a new NB. The new NB typically accepts the request unless under extreme conditions. In contrast, examples of the present disclosure enable endpoint devices from one or more MNOs to be served via a PCN. For instance, in one example, handover procedures of the present disclosure may be executed through rApps and xApps deployed within the PCN and MNO radio access network (RAN) intelligent controllers (RICs) in an Open RAN (ORAN) architecture. These apps may integrate custom logic and data-driven machine learning (ML) for offload/handover decision making. Thus, examples of the present disclosure may utilize collective intelligence and data analytics from both the MNO and PCN sides to enhance the decision-making processes through the deployment of rApps and xApps at respective RICs. The data-driven approach of the present disclosure may incorporate various factors including historical patterns as well as real-time measurements of cell load, endpoint device behavior, quality of service (QoS)/quality of experience (QoE), etc. Furthermore, the MNO can consider the cost of using PCN resources and the PCN can consider the potential reward or penalty for serving endpoint devices from the MNO while guaranteeing certain level of services for its own endpoint devices/users.

In one example, the present disclosure may include a service level agreement (SLA) between a MNO and a PCN which may include rewards and penalties to enhance the collective QoS/QoE for endpoint devices/users of both the MNO and PCN. In one example, the present disclosure may incorporate one or more game theory models, such as non-cooperative and Stackelberg games, to model the interactions among collaborative, self-interested entities (PCN and MNO) within a multi-agent system. In one example, an objective may be a robust framework, (e.g., formalized as a SLA) that incentivizes both the PCN and the MNO to actively participate in a collaborative resource and infrastructure sharing system. The thresholds for service, as well as corresponding incentives/rewards and penalties, may align the interests of PCNs and MNOs, promoting mutually beneficial cooperation while ensuring fairness and the confidentiality of each network’s private objectives.

In one example, the present disclosure may deploy rApps to analyze and forecast user/endpoint device behavior, cell load, network congestion, and resource availability to optimize resource allocation and make data-informed decisions regarding endpoint device handover, the admission and post-admission reassignment processes, and so forth. In addition, in one example, the present disclosure may deploy xApps at MNO and PCN RICs integrating custom logic and data-driven artificial intelligence (AI) and/or machine learning (ML) algorithms for coordinated endpoint device handover/offloading and admission/post-admission control to enhance decision-making processes. In one example, the MNO RIC may initiate a handover procedure for offloading endpoint devices from the MNO to the PCN by evaluating the current and anticipated network load, potential benefits, and costs based on predefined objectives and performance metrics. In response to offload/handover requests, the PCN RIC may implement an admission control strategy for accepting offloading requests from MNOs in accordance with network capacity and SLA factors. In one example the PCN RIC may further implement a post-admission control strategy for continuous monitoring of network conditions and potential reassignment decisions of public endpoint devices (e.g., endpoint devices admitted from the MNO).

To illustrate, in one example, a cell load prediction (CLP) rApp running in a non-real-time (non-RT) RIC of a MNO may be responsible for collecting data over a period of time and predicting the cell load in the MNO network. An accompanying traffic steering (TS) xApp running in a near-real-time (near-RT) RIC of the MNO may be responsible for a handover decision in real time to optimize throughput for an endpoint device. The MNO can consider (a) the overall current and anticipated load on the current serving cells and the anticipated impact of handing over an endpoint device, (b) the historical success of the handover requests and the user experience of the endpoint devices that were handed over in the past, and (c) a cost of using the PCN. On the other hand, the PCN may deploy an admitted user behavior prediction (AUBP) rApp and cell load prediction (CLP) rApp in a non-RT RIC of the PCN. These apps may be responsible for predicting patterns of public endpoint devices admitted to the PCN and for predicting the cell load in the PCN network. In one example, a PCN may further deploy a user admission control (UAC) xApp and post-admission control (PAC) xApp, running in a near-RT RIC of the PCN. These apps may be responsible for admission control decisions for handover requests from a MNO and may further control the reassignment of endpoint devices back to the MNO in accordance with network capacity and service level agreement (SLA) thresholds. The PCN can consider the current and near future load of its own users, the anticipated load of the new endpoint devices from the MNO, as well as the potential reward/penalty, e.g., according to the SLA.

Technical advantages of the present disclosure may include but are not limited to:
Providing improved service capacity, geographic coverage, and throughput (and/or other QoS/QoE factors) for endpoint devices served by the MNO through utilization of the PCN;
Increasing the availability of PCN networks offered by the MNO, e.g., to enterprise users through the opportunity to offset the cost of deployment with rewards earned in accordance with a SLA;
enhancing disaster recovery and resilience of a MNO by integrating diverse infrastructure and service capabilities from PCNs, e.g., enabling the MNO to maintain service continuity and sustain high performance, especially during network disruptions or emergencies;
supporting expedited rollout of innovative solutions and services without significant upgrades or investments to the core infrastructure (e.g., where the deployment of new technologies may be facilitated by adaptable and scalable infrastructure); and
integration with an ORAN architecture for adaptability and sustained utility within the future of network architecture and operations, e.g., by adhering to ORAN principles, which promote a modular approach to network architecture, different components and technologies may seamlessly work together, enhancing network openness and interoperability, and helping to ensure that examples of the present disclosure remain relevant and are not rendered prematurely obsolete.

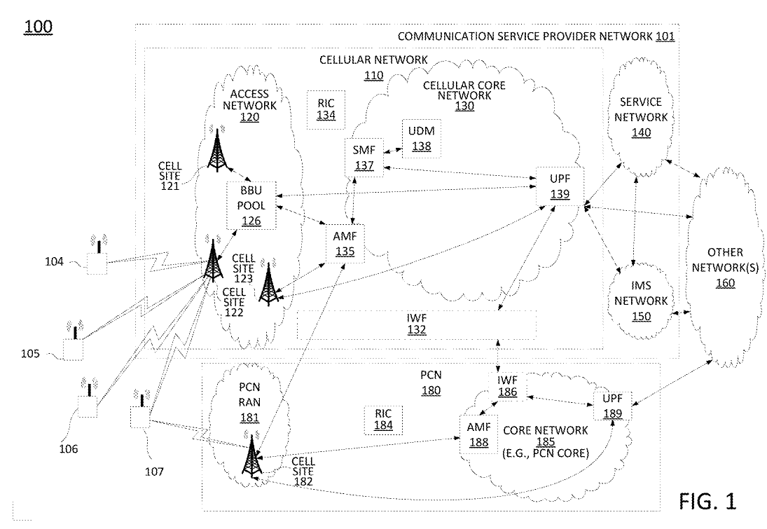

These and other aspects of the present disclosure are discussed in greater detail below in connection with the examples of FIGS. 1-5.

FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 5G/4G/Long Term Evolution (LTE) hybrid network, or the like), a service network 140, and an IP Multimedia Subsystem (IMS) network 150. The system 100 may further include other networks 160 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the progression of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, the base stations may have a distributed architecture comprising centralized units (CUs) (e.g., represented by BBU pool 126) and associated distributed units (DUs) (e.g.,represented by BBU pool 126 and/or deployed at cell sites 121 and 122) and radio units (RUs) (e.g., deployed at cell sites 121 and 122). In one example, these components may be in accordance with an O-RAN architecture, e.g., an Open-CU (O-CU), an Open-DU (O-DU), an Open-RU (O-RU), or the like. In accordance with the present disclosure, any one or more of cell sites 121-123 may be deployed with antenna and radio infrastructures, including multiple input multiple output (MIMO) capable radios, millimeter wave antennas, and so forth.

In one example, the cellular core network 130 provides various functions that support wireless services in the 5G environment. In one example, cellular core network 130 is an Internet Protocol (IP) packet core network that supports both real-time and non-real-time service delivery across a 5G network, e.g., as specified by the 3GPP standards. In one example, cell sites 121 and 122 in the access network 120 are in communication with the cellular core network 130 via baseband units in BBU pool 126. As illustrated in FIG. 1, cellular core network 130 further comprises 5G components, including: an access and mobility management function (AMF) 135, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., a mobility management entity (MME), and so forth. In one example, SMF 137 may perform endpoint device IP address management, UPF selection, UPF configuration for endpoint device traffic routing to an external packet data network (PDN), charging data collection, quality of service (QoS) enforcement, and so forth. UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. UDM 138 may perform user identification, credential processing, access authorization, registration management, mobility management, subscription management, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 160 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 160 may include different types of networks. In another example, the other networks 160 may be the same type of network. In one example, the other networks 160 may represent the Internet in general. In this regard, it should be noted that any one or more of service network 140, other networks 160, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs). For example, AMF 135, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

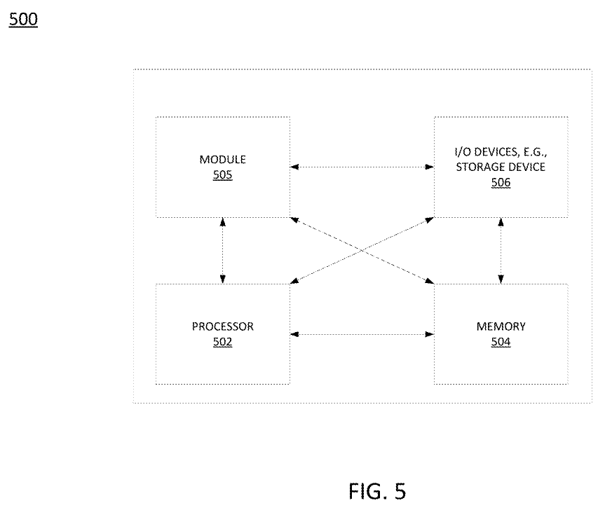

FIG. 1 also illustrates various endpoint devices 104-107, e.g., user equipment (UEs). Endpoint devices 104-107 may each comprise a cellular telephone, a smartphone, a tablet computing device, a laptop computer, a pair of computing glasses, a wireless enabled wristwatch, or any other cellular-capable mobile telephony and computing devices (broadly, “an endpoint device”). In one example, endpoint devices 104-107 may each be equipped with one or more directional antennas, or antenna arrays (e.g., having a half-power azimuthal beamwidth of 120 degrees or less, 90 degrees or less, 60 degrees or less, etc.), e.g., multiple input-multiple output (MIMO) antenna(s) to receive multi-path and/or spatial diversity signals. Some or all of the endpoint devices 104-107 may also include a gyroscope and compass to determine orientation(s), a global positioning system (GPS) receiver for determining a location (e.g., in latitude and longitude, or the like), and so forth. In one example, some or all of the endpoint devices 104-107 may a built-in/embedded barometer from which measurements may be taken and from which an altitude or elevation of the respective endpoint device may be determined. In one example, some or all of the endpoint devices 104-107 may also be configured to determine location/position from near field communication (NFC) technologies, such as Wi-Fi direct and/or other IEEE 802.11 communications or sensing (e.g., in relation to beacons or reference points in an environment), IEEE 802.15 based communications or sensing (e.g., “Bluetooth™,” “ZigBee™,” etc.), and so forth. In addition, in one example, each of the endpoint devices 104-107 may comprise 104 or a portion of a computing system, such as computing system 500 depicted in FIG. 5.

As illustrated in FIG. 1, endpoint devices 104-107 may register and attach to cell site 122 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the cell site 122 and establish a radio resource control (RRC) communication, transmitting a registration/attach request, performing authentication procedures, establishing a default protocol data unit (PDU) session, e.g., including bearer assignment, and so forth.

In one example, system 100 may also include a private cellular network (PCN 180), which may include a PCN radio access network (RAN) 181 having at least one cell site 182 (e.g., a base station, such as an eNB and/or gNB, or the like) and a core network 185. The core network 185 may be the same or similar to cellular core network 130, but may be scaled for a capacity of the PCN 180 (e.g., typically smaller than that of cellular network 110/communication service provider network 101). For instance, core network 185 may include an AMF 188, a UPF 189, and so forth. For ease of illustration, only several components of core network 185 are specifically illustrated in FIG. 1. However, it should be understood that core network 185 may include various other components, such as a SMF, a UDM, and so forth. In one example, cell site 182 may comprise, for example, a home eNodeB (HeNB) or home gNodeB, (HgNB), a “small cell,” such as a femtocell, a microcell, etc., and/or a “low power” gNB. For instance, cell site 182 may have a range of 2 kilometers or less, while cell sites 121, 122, and/or 123 may have a range of up to 35 kilometers or more. However, in other examples, any one or more of cell sites 121, 122, and/or 123 may have a different range, such as examples in which one or more of cell sites 121, 122, and/or 123 may transmit in ultra-wideband and/or millimeter wave band(s) and may have a correspondingly shorter range/coverage.

In one example, PCN 180 may be made available for endpoint device offloading by MNOs, such as communication service provider network 101. For instance, a host PCN 180 may share radio access network (RAN) resources (and in some cases, all or some core network assets). In the present example, any of endpoint devices 104-107 may be directed by communication service provider network 101 to register and attach to cell site 182 to obtain network services from PCN RAN 181 and/or PCN 180. This may include detecting a primary synchronization signal (PSS), secondary synchronization signal (SSS), physical broadcast channel (PBCH), and/or demodulation reference signal (DMRS), engaging a random access channel to report to the cell site 182 and establish a radio resource control (RRC) communication, transmitting a registration/attach request, performing authentication procedures, establishing a default protocol data unit (PDU) session, e.g., including bearer assignment, and so forth.

In one example, endpoint devices/UEs associated with communication service provider network 101 may be served via PCN RAN 181, while still being served via cellular core network 130. To illustrate, in one example, PCN RAN 181 and cell site 182 may connect to AMF 135 of cellular core network 130. In one example, PCN RAN 181 and cell site 182 may further connect to AMF 135 via an inter-working function (IWF) 132. For instance, IWF 132 may provide an anchor point for secure communications between PCN RAN 181/cell site 182 and EPC network 130. In particular, since PCN RAN 181 may be associated with an enterprise, it may be more vulnerable to attack and compromise, and may provide a vector for entry into communication service provider network 101 and cellular core network 130. Thus, in one example, IWF 132 may establish an IP security (IPsec) tunnel between itself and the cell site 182. The IWF 132 may132mprise a security gateway, a firewall, or the like, and may perform similar functions to analyze and filter traffic from cell site 182 before passing the traffic to AMF 135, or alternatively dropping the traffic or passing the traffic to a quarantine device or other network based devices, e.g., for further analysis, malicious traffic signature generation, and so forth.

Alternatively, or in addition, endpoint devices offloaded by communication service provider network 101 (e.g., any one of the endpoint devices 104-107, etc.) may be served by PCN RAN 181 and core network 185. For example, the private cellular network 180 may deploy and operate its own cellular core network 185 (or “packet core”), the components of which may provide the same or similar functions as the corresponding components of cellular core network 130 as discussed above. In this regard, core network 185 may also be connected to cellular core network 130 via IWF 132. In one example, core network 185 may include its own IWF 186 which may provide the same or similar functions as IWF 132. In one example, components of core network 185 may communicate with components of cellular core network 130 via UPF 139 and UPF 189, e.g., with IWFs 132 and 186 in the communication path to monitor the communications and to provide security screening and/or other services. In one example, each of the IWFs 132 and 186 may comprise a security edge protection proxy (SEPP), a 3GPP interworking function, a UPF, an evolved packet data gateway (ePDG), a non-3GPP interworking function (N3IWF), a trusted wireless local area network (WLAN) authentication, authorization, and accounting (AAA) proxy (TWAP), and/or a trusted WLAN access gateway (TWAG). In other words, either or both of the IWFs 132 and1326 may comprise a device that is configured to provide functions of a 3GPP IWF, a SEPP, a UPF, a ePDG, a TWAP, and/or a TWAG.

As further illustrated in FIG. 1, each of the cellular network 110 and PCN 180 may also include a RAN intelligent controller (RIC), e.g., RIC 134 and RIC 184, respectively. For instance, in an O-RAN architecture, a RIC may be deployed for managing and controlling various RAN components/functions, e.g., CUs, DUs, and RUs. For example, RICs 134 and 184 may each comprise a platform that hosts various RAN applications (e.g., xApps/rApps) that may be used to configure and reconfigure various components of cellular network 110 and PCN 180, respectively. In one example, aspects of RIC 134 and/or RIC 184 may represent functionality of a self-optimizing network orchestrator, or vice versa. In one example, RIC 134 and/or RIC 184 may request and/or subscribe to various information that may be obtained and stored by other components of the respective cellular network 110 or PCN 180, such as data stored by a network data analytics function (NWDAF). Such information may include time-stamped RAN performance indicators (e.g., KPIs for various time blocks/intervals), RAN environment state information (e.g., RAN parameters and/or settings associated with the time blocks/intervals for which performance indicators may be measured/collected), endpoint device utilization information, or the like. Alternatively, or in addition RIC 134 and/or RIC 184 may obtain various information from RAN components or other network elements directly (e.g., without an NWDAF or other components serving as an intermediary). In one example, RIC 134 and/or RIC 184 may comprise a computing platform/system hosting various RAN applications, which may comprise programs, code, etc. running on computing hardware of the respective RIC. As noted above, in one example, the RAN applications may include xApps and rApps.

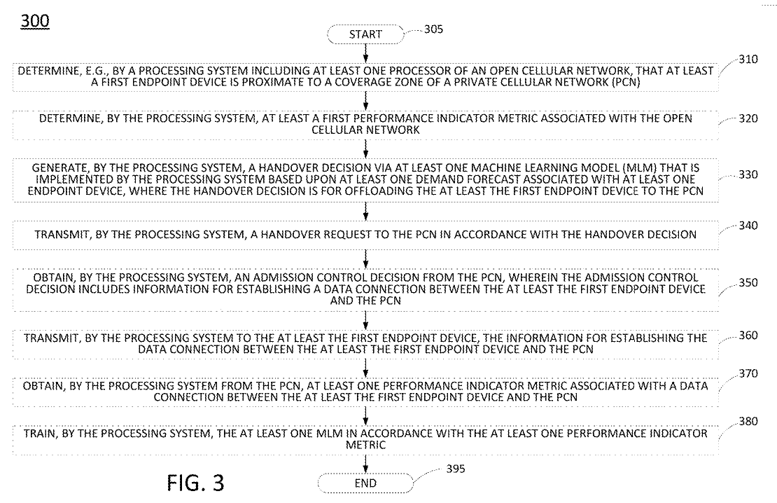

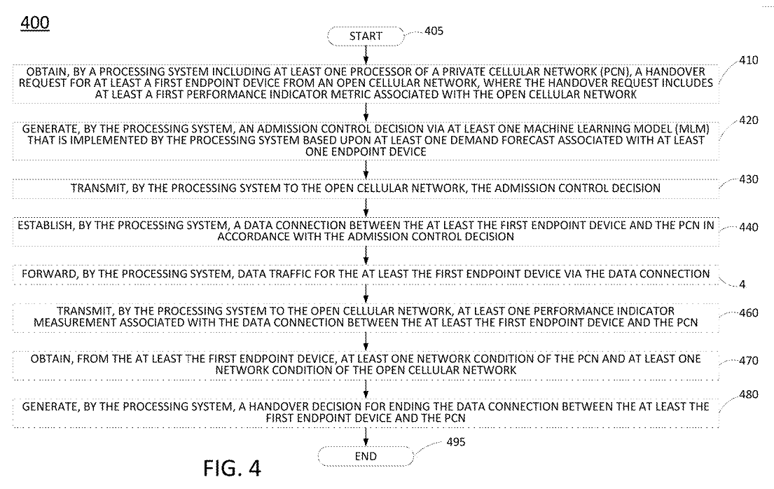

In one example, aspects of the present disclosure for generating a handover decision for offloading at least a first endpoint device to a private cellular network via at least one machine learning model implemented by a processing system of an open cellular network based upon at least one demand forecast associated with at least one endpoint device, e.g., as described in greater detail below in connection with the example method 300 of FIG. 3, may be performed by RIC 134. Similarly, aspects of the present disclosure for generating an admission control decision for at least a first endpoint device from an open cellular network via at least one machine learning model implemented by a processing system of a private cellular network based upon at least one demand forecast associated with at least one endpoint device, e.g., as described in greater detail below in connection with the example method 400 of FIG. 4, may be performed by RIC 184. In this regard, in one example, RIC 134 and/or RIC 184 may comprise all or a portion of a computing device or system, such as computing system 500, and/or processing system 502 as described in connection with FIG. 5 below, and may be configured to perform various operations in connection with examples of the present disclosure for generating an admission control decision for at least a first endpoint device from an open cellular network via at least one machine learning model implemented by a processing system of a private cellular network based upon at least one demand forecast associated with at least one endpoint device and/or examples of the present disclosure for generating a handover decision for offloading at least a first endpoint device to a private cellular network via at least one machine learning model implemented by a processing system of an open cellular network based upon at least one demand forecast associated with at least one endpoint device.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In addition, the foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For instance, intermediate devices and links between cell sites 121-123, AMF 135, SMF 137, UDM 138, and/or UPF 139, and other components of system 100 are omitted for clarity, such as additional routers, switches, gateways, and the like. Likewise, alternative or additional interfaces may be omitted from illustration in FIG. 1, such as link between UFP 139 and UPF 189, e.g., without IWF 132 and/or IWF 138 as an intermediary or intermediaries. In addition, due to the numerous connections between RICs 134 and 184 and other components of cellular network 110 and PCN 180, respectively, any and all of these connections or interfaces are omitted from illustration in FIG. 1. Thus, it should be understood that each of the RICs 134 and 184 may be directly or indirectly connected to various other components of cellular network 110 and PCN 180, respectively. Alternatively, or in addition, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In addition, cellular core network 130 may also include additional 5G NG core components, such as: a policy control function (PCF), an authentication server function (AUSF), a network repository function (NRF), a NWDAF, and other application functions (AFs) (and similarly for core network 185).

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network). For instance, in non-standalone (NSA) mode architecture, LTE radio equipment may continue to be used for cell signaling and management communications, while user data may rely upon a 5G new radio (NR), including millimeter wave communications, for example. Thus, for instance, in accordance with the present disclosure, cellular core network 130 may further include other types of wireless network components e.g., 2G network components, 3G network components, 4G/Long Term Evolution (LTE) network components, etc. In other words, cellular core network 130 may comprise an integrated network, e.g., including any two or more of 2G-6G infrastructures and technologies, and the like (and similarly for core network 185). In addition, access network 120 may include both 4G/LTE and 5G/NR radio access network infrastructure. For example, access network 120 may include 4G/LTE base station equipment, e.g., an eNodeB. In addition, access network 120 may include cell sites comprising both 4G and 5G base station equipment, e.g., respective antennas, feed networks, baseband equipment, and so forth. Similarly, in one example, any one or more of cell sites 121-123 may comprise 2G, 3G, 4G and/or LTE radios, e.g., in addition to 5G new radio (NR), or gNB functionality. For instance, in various examples, the present disclosure may further include the use of an inter-radio access technology (inter-RAT) air interface, e.g., with primary and secondary cell groups and/or split bearers or the like (and similarly for PCN RAN 181). Thus, these and other modifications are all contemplated within the scope of the present disclosure.

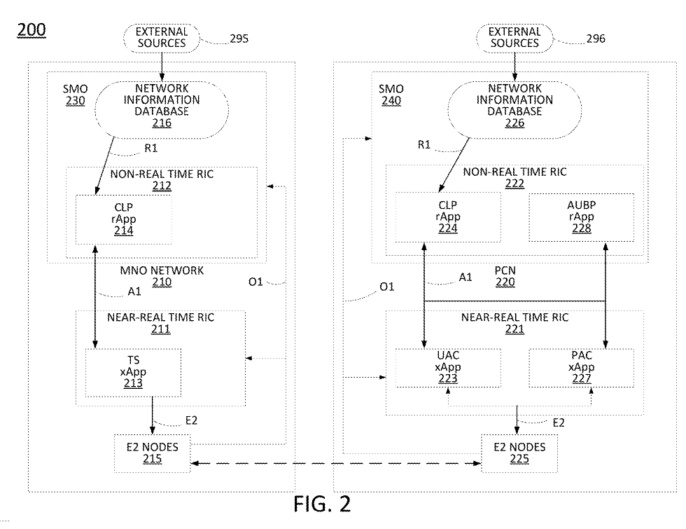

To further aid in understanding the present disclosure, FIG. 2 illustrates an example system 200 of the present disclosure including mobile network operator (MNO) and private cellular network (PCN) RAN intelligent controllers (RICs). In the present example, the MNO network 210 may include a near-real time (near-RT) RIC 211 and a service management and orchestration (SMO) 230 including a non-real time (non-RT) RIC 212 and network information database 216. Similarly, the PCN 220 may include a near-RT RIC 221 and a SMO 240 including a non-RT RIC 222 and network information database 226. It should be noted that although these may be illustrated as separate components within the system 200, in other, further, and different examples, near-RT and non-RT RIC components may be integrated at a single device or on a shared hardware platform, e.g., without physical segregation of such components.

In one example, the cell load prediction (CLP) rApp 214 running in the non-RT RIC 212 of MNO 210 may be responsible for collecting data over time and predicting the cell load in MNO network 210. An accompanying traffic steering (TS) xApp 213, running in the near-RT RIC 211 may be responsible for handover decisions in real time/near-real time to optimize endpoint device throughput. The MNO network 210 can consider (a) the overall current and anticipated load on the current serving cells and the anticipated impact of handing over an endpoint device, (b) the historical success of the handover requests and the user experience (e.g., QoS/QoE) of the endpoint devices that were handed over in the past, and in one example may further consider (c) the cost of using the PCN 220.

The admitted user behavior prediction (AUBP) rApp 228 and cell load prediction (CLP) rApp 224 running in the non-RT RIC 222 of the PCN 220 may beresponsible for predicting patterns of endpoint devices admitted to the PCN 220 (e.g., from a public/macro cellular network/MNO, e.g., MNO network 210) and for predicting the cell load in the PCN 220. The user admission control (UAC) xApp 223 and post-admission control (PAC) xApp 227 running in the near-RT RIC 221 may be responsible for deciding on the acceptance of handover requests from MNO network 210 and may further control endpoint device reassignment in accordance with network capacity and SLA factors. The PCN 220 can consider (a) the current and near future load of its own endpoint devices (or all currently served/attached endpoint devices), (b) the anticipated load of one or more new endpoint devices to be admitted from MNO network 210, as well as (c) the potential reward/penalty per the SLA.

In this regard, the MNO network 210 and PCN 220 may initially formulate and establish agreed upon incentive mechanisms, leveraging historical data and identify patterns to inform the design process. In one example, MNO network 210 and PCN 220 may collaboratively utilize game theory models to analyze the interactions between different parties, with a goal of creating mechanisms that incentivize the MNO network 210 and PCN 220 to participate in the collaborative system, optimizing the interests of each of the MNO network 210 and PCN 220 while ensuring mutual benefits. Thus, MNO network 210 and PCN 220 may negotiate or solve the incentive mechanism to determine the optimal or equilibrium decisions. The resulting decisions may form the basis of a service level agreement (SLA), which outlines responsibilities, rewards, and penalties for each party. In one example, the SLA may define objective functions and constraints for service provisioning in subsequent steps (e.g., which may be automatically executed by respective computing components of MNO network 210 and PCN 220, respectively, such as near-RT RIC 211, non-RT RIC 212, near-RT RIC 221, and/or non-RT RIC 222).

In one example, SLA responsibilities of PCN 220 may include provisioning specified network resources, including bandwidth and cell capacity. For instance, according to the agreed specifications, PCN 220 may be expected to maintain a minimum network availability level. On the other hand, MNO network 210 may have the responsibility to effectively manage traffic load to prevent network congestion, maintain quality of service standards, and avoid overloading the capacity of PCN 220 to ensure that the core operations and service quality of the PCN 220 provided to its own native endpoint devices remain unaffected. As an example, a SLA may define a minimum number of endpoint devices from MNO network 210 that should be served by PCN 220 at any particular time, a total throughput and/or average throughput per endpoint device, a retainability, e.g., a likelihood that an endpoint device is not returned to the MNO network 210 prematurely (e.g., prior to an endpoint device no longer needing service and/or prior to the MNO network 210 requesting that an endpoint device be handed back to MNO network 210). To further illustrate, a SLA condition may be: accepting at least up to 100 simultaneous endpoint devices with a total throughput of no less than 200 Mbps (when demanded by the endpoint device) and a 99% retainability. Another example SLA condition may be: simultaneous acceptance/admission of up to at least 10 endpoint devices, each with a minimum throughput of 10 Mbps and 99% retainability.

As noted above, the SLA may further establish rewards, which can take several forms, such as usage-based rewards, e.g., providing financial incentives based on traffic volume managed without congestion, per-contract bonuses awarded if all SLA conditions are met, etc. In one example, performance bonuses, such as service credits can be given for maintaining network availability above agreed thresholds or other performance indicators (e.g., key performance indicators (KPIs)). Alternatively, or in addition, a SLA may formalize penalties, which can be implemented to ensure that both parties remain accountable and committed to maintaining high standards of service and operational excellence according to the SLA. For instance, if the PCN 220 fails to maintain the agreed network availability or QoS levels, it may incur financial penalties or service restrictions from MNO network 210. Some penalties may compensate the MNO network 210 for any negative impact on its service quality and user experience. Likewise, if the MNO network 210 overloads the capacity of PCN 220 or fails to adhere to SLA handover and resource utilization levels, MNO network 210 may face penalties such as increased charges or reduced access to resources of PCN 220. In one example, a specific penalty can also be imposed when an endpoint device previously admitted to the PCN 220 from MNO network 210 is returned prematurely to the MNO network 210. For instance, such a penalty may discourage frequent offloading, thereby maintaining network stability and service quality. Penalty amounts may be based on factors such as the duration of service, resource utilization, frequency of occurrences, and the impact on service quality.

The CLP rApp 214 of the non-RT RIC 212 of MNO network 210 and the AUBP rApp 228 and CLP rApp 224 of the non-RT RIC 222 of PCN 220 may be responsible for collecting, storing, and processing historical data from various sources, such as endpoint devices, cell sites/base stations, service providers, and other network elements to make predictions/forecasts. This data may include performance metrics/performance indicators (e.g., KPIs), endpoint device/user behavior patterns fed from the O1 interface, the network information databases 216 and 226 (e.g., via R1 interface), and/or external sources 295 and 296. In one example, one or more machine learning models (MLMs) may be trained, e.g., via the non-RT RICs 212 and 222 to generate cell load predictions and endpoint device usage/behavior forecasts. These models can be trained independently by each RIC or collaboratively using decentralized or vertical federated learning approaches, which may preserve data privacy and reduce computational costs. The trained models may be passed to the corresponding xApps using respective A1 interfaces.

In this regard, it should be noted that as referred to herein, a machine learning model (MLM) (or machine learning-based model) may comprise a machine learning algorithm (MLA) that has been “trained” or configured in accordance with input data (e.g., training data) to perform a particular service, e.g., to: (a) forecast/predict cell loads, (b) forecast/predict endpoint device/user behaviors, (c) identify endpoint devices that are candidates for handover, (d) make handover decisions for endpoint devices, (e) make handover admission decisions, and/or (f) make endpoint device return decisions (e.g., for returning endpoint devices from a PCN network back to a MNO network). These MLMs may use various input data, such as network performance data and/or network configuration data stored by the respective network information databases 216 and 226, data from external sources, such as weather data, event data (such as a really simple syndication (RSS) feed identifying sporting events, concerts, etc.), vehicular traffic data, and so forth. In one example, an input of one MLM may comprise an output of another MLM. For instance, a MLM of TS xApp 213 may have an input comprising a cell load prediction that may comprise an output of an MLM of CLP rApp 214. Similarly, an MLM of the post-admission control (PAC) xApp 227 may have an input that comprises an output of the AUBP rApp 228 (e.g., predicted user behavior) and/or the CLP rApp 224 (e.g., predicted network load).

Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), generative adversarial networks (GANs), decision tree algorithms/models, k-nearest neighbor (KNN) clustering algorithms/models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. In one example, MLMs of the present disclosure may be in accordance with a MLA/MLM template from an open source library, such as OpenCV, which may be further enhanced with domain specific training data. In one example, different MLMs may be trained and deployed for different network failure types, for different locations/areas, network elements, and or network zones, for different classes of endpoint devices, and so forth.

The near-RT RICs 211 and 221 may include decision-making functions of TS xApp 213, UAC xApp 223, and PAC xApp 227. These xApps continuously receive real-time data from network elements (e.g., E2 nodes 215 and 225) via the E2 interfaces along with outputs related to cell resource utilization and endpoint devices behavior patterns derived from historical data, which may be provided by rApps through the A1 interfaces, to make data-driven decisions. In one example, endpoint device offloading decisions of TS xApp 213 and admission control decisions of UAC xApp 223 may employ a reinforcement learning (RL) or optimization approach. For instance, each of the TS xApp 213 and UAC xApp 223 may explore a respective solution space by interacting with a digital twin/simulation environment, thereby deriving the optimal policy for the decision-making. These xApps can be trained separately or jointly, depending on the operators’ agreement.

To further illustrate, an endpoint device handover process may be orchestrated by the TS xApp 213, which may identify endpoint devices that could benefit from offloading, and which may assess the quality of potential primary cells based on metrics such as reference signal received power (RSRP), reference signal received quality (RSRQ), signal-to-interference-and-noise (SINR) ratio reported by endpoint devices, etc. In one example, TS xApp 213 may thus evaluate available endpoint devices and the state of MNO network 210 to determine whether and when to initiate an offloading request. When a handover/offload is deemed appropriate by TS xApp 213, a request may be initiated to PCN 220 to admit one or more endpoint devices from MNO network 210. For instance, the request may be passed via respective E2 nodes 215 and 225.

The request may be evaluated by a corresponding UAC xApp 223, which may decide on an acceptance or rejection based on its admission control strategy, e.g., according to a MLM and/or RL-based framework considering current and/or predicted network load/capacity, predicted endpoint device/user behavior, and any potential reward or penalty. Assuming offload/admission of one or more endpoint devices is approved and one or more PDN sessions are established with the PCN 220 for such endpoint devices, the post-admission control (PAC) xApp 227 may monitoring the resource consumption of these admitted endpoint devices on an ongoing basis. The PAC xApp 227 may decide whether and when to reassign endpoint devices back to the MNO network 210 for load balancing, for maintaining optimal network performance and/or QoS/QoE expectations for existing users/endpoint devices, etc. Such reassignment may be evaluated in view of any potential penalties that may be incurred, reflecting the expectation to adhere to the agreed-upon policies of the SLA and to maintain network efficiency.

In one example, MNO network 210 and/or PCN 220 may employ feedback loops for continuous, ongoing improvement. For example, xApps monitor the outcomes of their decisions, tracking success rates, handover delays, and user/endpoint device experience metrics. This performance data may be sent back to the Non-RT RICs 212 and 222 for rApps to re-train MLMs with feedback data. Updated MLMs may then be redeployed (at the rApps and/or at the xApps), ensuring continuous improvement in the handover process and overall network optimization.

It should be noted that FIG. 2 illustrates just one example architecture and that other, further, and different examples may have a different form. For instance, in one example, near-RT RIC 211 may alternatively or additionally communicate with near-RT RIC 221 without involvement of E2 nodes 215 and 225. In another example, the network information databases 216 and 226 may be part of the non-RT RIC 212 and non-RT RIC 222, respectively. In addition, it should be noted that while functions of MNO network 210 and PCN 220 are illustrated as respective rApps and xApps, in various examples, one or more functions of one or more such apps may be combined with one another, may be deployed in a different one of a non-RT RIC or near-RT RIC, and so forth. Similarly, in one example, MNO network 210 and/or PCN 220 may not maintain a segregation of non-RT and near-RT RICs. For instance, while rApps may generally operate with time horizons of 100 ms – 1 second or more and while xApps may generally operate with shorter time horizons, in one example, the present disclosure does not require that any specific distinctions are maintained. In one example, rApps may give updates to xApps periodically and/or may provide higher level summaries across sets of endpoint devices, clusters of cells, etc.

In one example, a handover request from the MNO network 210 to the PCN 220 may include additional information (e.g., beyond 3GPP) such as endpoint device usage metrics and/or behavior predictions (e.g., throughput, demand, KPIs, movement/distribution, etc.) in a past, current, or future time window. Alternatively, or in addition, additional information from MNO network 210 may include a time duration estimate or distribution (based on historical data), e.g., how long an endpoint device is expected to stay on the PCN 220. In one example, the additional information may include endpoint device-specific preferences/demands. For instance, in accordance with the SLA, the MNO network 210 may210 permitted to request a minimum throughput or throughput range (e.g., up to a maximum), a minimum expected latency, etc. In one example, different rewards and/or penalties may be associated with different tiers of services (e.g., different throughputs, etc.) which may be monitored in accordance with the endpoint device-specific request. In still another example, MNO network 210 and PCN 220 may share endpoint device movement/location data and/or may provide anticipated offloading and/or returning times based on endpoint device location tracking by a currently serving network. In this regard, it should be noted that examples of the present disclosure may more generally provide the extended ability to share information back and forth between MNO network 210 and PCN 220. Thus, while PCN 220 and MNO network 210 may have their own xApps, rApps, and MLMs thereof, additional performance gains may be realized via the sharing of additional information such as described.

Nevertheless, it should be appreciated that in some examples, mutual learning and optimization may occur even without explicit sharing of additional information. For example, the MNO network 210 may be initially configured to offload the most data- consuming endpoint devices. However, the MNO network 210 may learn that the PCN 220 accommodates a substantially fewer number of endpoint device offload requests when the most data-consuming endpoint devices are the only subjects of the offload requests. In other words, the MNO network 210 may learn over time that it can offload more moderate data-consuming endpoint devices, and the overall data and/or bandwidth/throughput utilization offloaded to PCN 220 may be higher than where the MNO network 210 tries to always offload the heaviest consuming endpoint devices. In one example, this knowledge may be manifested by a MLM of TS xApp 213 adapting to learn a different strategy for offloading users based upon a maximization of an optimization criterion. Notably, such adaptation does not require explicit messaging about UE demands but is learned from externally visible information (e.g., an admit/reject decision) and/or is visible from tracking the throughput of UE after it is admitted to the PCN.

In one example, the MNO network 210 may request that the PCN 220 accommodate more endpoint devices than the PCN 220 is obligated to admit in accordance with the SLA. In such case, in one example, PCN 220 may respond to the MNO network 210 with the service level that it can anticipate providing for the quantity of endpoint devices being requested. The MNO network 210 may then proceed with the current request or may revise the request, e.g., to request offloading of fewer endpoint devices and/or one or more different endpoint devices, etc. In one example, the MNO network 210 may exceed a SLA condition by sending too much traffic to the PCN 220. In one example, PCN 220 (e.g., via UAC xApp 223) may conditionally allow/admit the endpoint device(s), but may reduce bandwidth/maximum throughput for all admitted endpoint devices from the MNO network 210. In addition, in such case, if the QoS is too low for one or more of these endpoint devices, the PCN 220 will not be penalized, but the responsibility will be on the MNO network 210 with respect to its endpoint devices/customers. Thus, these and other modifications are all contemplated within the scope of the present disclosure.

FIG. 3 illustrates a flowchart of an example method 300 for generating a handover decision for offloading at least a first endpoint device to a private cellular network via at least one machine learning model implemented by a processing system of an open cellular network based upon at least one demand forecast associated with at least one endpoint device, in accordance with the present disclosure. In one example, steps, functions and/or operations of the method 300 may be performed by one or more component of FIGS. 1 and/or 2, e.g., RIC 134, near-RT RIC 211 and non-RT RIC 212, etc., or one or more of such components in conjunction with one or more other components, such as one or more base stations, BBUs, CUs, DUs, a NWDAF, an IWF, etc. In one example, the steps, functions, or operations of method 300 may be performed by a computing device or system 500, and/or a processing system 502 as described in connection with FIG. 5 below. For instance, the computing device or system 500 may represent at least a portion of device or system deployed in a cellular network that is configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 500 may collectively function as a processing system. For illustrative purposes, the method 300 is described in greater detail below in connection with an example performed by a processing system, such as processing system 502. The method 300 begins in step 305 and proceeds to step 310.

At step 310, a processing system of an open cellular network (e.g., a public cellular network/MNO) determines that at least a first endpoint device is proximate to a coverage zone of a private cellular network (PCN). For instance, the processing system may track the location(s) of the at least the first endpoint device via voluntary reporting from the endpoint device(s) and/or via approximation based upon serving cell site/base station, sector, etc., via base station triangulation techniques, or the like. In one example, the coverage zone of the PCN may be predetermined. For instance, the MNO and the PCN may share coverage maps with each other in advance or via periodic data exchange, e.g., via respective RICs, rApps, or the like. Alternatively, or in addition, endpoint devices may report to the processing system when the endpoint devices detect the availability of a PCN, such as by detecting a primary synchronization signal (PSS), secondary synchronization signal (SSS), physical broadcast channel (PBCH), etc. In this regard, the term “proximate” may refer to being within an actual coverage zone of at least one cell site/base station of the PCN or sufficiently close (e.g., as predefined for the processing system by an MNO operator) to be considered at or near to the coverage zone of the PCN.

At optional step 320, the processing system may determine at least a first performance indicator metric associated with the open cellular network. For instance, the at least the first performance indicator metric may comprise one or more performance indicator measurements associated with the open cellular network. For example, the at least the first performance indicator measurement may be associated with the at least the first endpoint device, but could be associated with other endpoint devices besides the at least the first endpoint device. This can be a data utilization, or throughput, applications used/data traffic types, a call volume, a text volume, an overall data volume, etc. To further illustrate, the at least the first performance indicator measurement associated with the open cellular network may include a measure of a data throughput associated with the at least the first endpoint device, an endpoint device demand grouping associated with the at least the first endpoint device (e.g., customer segment, such as low usage, medium usage, heavy usage, etc.), or the like. It should be noted that the metrics may be observed current metrics and/or historical metrics, or forecast metrics. Alternatively, or in addition, the at least the first performance indicator metric may comprise at least one quality of service (QoS) preference associated with the at least the first endpoint device. For example, the at least one QoS preference may include at least one of a minimum requested throughput or a maximum requested latency. For instance, the QoS preference(s) may be endpoint device-specific within permitted ranges as defined by a SLA. In one example the at least one QoS preference may be defined as one or more of a preferred QoS class identifier (QCI), an allocation and retention priority (ARP), or the like.

In one example, the at least the first performance indicator metric may comprise at least one demand forecast associated with at least one endpoint device. In one example, the at least one endpoint device may comprise the at least the first endpoint device. However, in another example, the at least one endpoint device may comprise at least one other endpoint device that is different from the at least the first endpoint device. In one example, the at least one demand forecast may include at least one of: a forecast throughput demand, a forecast call volume, a forecast call duration for one or more calls, a forecast session duration, a forecast mobility metric, or the like (e.g., associated with one or more of the at least one endpoint device). It should be noted that the mobility metric may be indicative of how much movement to expect of the at least one endpoint device (e.g., within the coverage area of the PCN and/or in general and/or during an anticipated time period in which the at least the at least one endpoint device will be within the coverage area of the PCN, and so forth). In still another example, the at least one demand forecast may alternatively or additionally comprise at least one cell load prediction as discussed above.

At step 330, the processing system generates a handover decision via at least one machine learning model (MLM) that is implemented by the processing system based upon at least one demand forecast associated with at least one endpoint device, where the handover decision is for offloading the at least the first endpoint device to the private cellular network. For instance, the at least one MLM may infer based on the demand forecast whether the request to handover will be successful, whether the PCN will provide service to the endpoint device(s) in compliance with SLA, whether it will be more cost effective to offload compared to serving the endpoint device(s) via the MNO directly (e.g., generally and/or as compared to the possibility of offloading other endpoint device(s), etc.), and so forth. In one example, the at least one MLM may comprise at least a first MLM that is configured to generate an output comprising the handover decision in response to an input vector comprising the at least one demand forecast associated with the at least one endpoint device. In one example, the at least one MLM may further comprise at least a second MLM that is configured to generate an output comprising the at least one demand forecast in response to an input vector comprising one or more performance indicator metrics associated with a utilization of the open cellular network by the at least one endpoint device. For instance, in one example, the at least one demand forecast may comprise a cell load prediction. In another example, the at least one demand forecast comprises an endpoint device behavior prediction. For instance, the endpoint device behavior prediction may include a forecast throughput demand, call volume, sessionduration, call duration, mobility metric, etc. In still another example, the at least the second MLM may include at least two MLMs to generate a cell load prediction and an endpoint device behavior prediction, respectively. In such an example, the at least the first MLM may be configured to generate the output of the handover decision in response to an input vector including both the cell load prediction and the endpoint device behavior prediction.

At step 340, the processing system transmits a handover request to the private cellular network in accordance with the handover decision (i.e., where the handover decision is that a handover is to be initiated). In one example, the handover request may include the at least the first performance indicator metric. In one example, the handover request may be received and processed by a RIC of the PCN. In one example, the handover request may be processed by the PCN in accordance with the example method 400 of FIG. 4 (discussed in greater detail below).

At optional step 350, the processing may obtain an admission control decision from the PCN. For instance, the admission control decision may include information for establishing a data connection between the at least the first endpoint device and the private cellular network, such as a cell identifier (ID), an authorization and/or authentication token, and so forth (i.e., where the admission control decision is to allow the offloading of the at least the first endpoint device).

At optional step 360, the processing system may transmit, to the at least the first endpoint device, the information for establishing the data connection between the at least the first endpoint device and the private cellular network. For instance, the processing system may transmit such information to the at least the first endpoint device while one or more PDN sessions between the open cellular network and the at least the first endpoint device remain active. Once the at least the first endpoint device attaches to the PCN, the one or more PDN sessions with the open cellular network may be released.

At optional step 370, the processing system may obtain from the PCN at least one performance indicator metric associated with a data connection between the at least the first endpoint device and the PCN. For instance, the at least the one performance indicator metric associated with the data connection between the at least the first endpoint device and the PCN may include one or more of: a throughput for the at least the first endpoint device via the data connection, an uplink received signal strength indicator, a jitter measurement for the at least the first endpoint device via the data connection, a quality of service (QoE) measure, etc. In one example, any or all of these measures may comprise average measures over a time period and/or a sequence of instantaneous metrics or samples, and so forth.

At optional step 380, the processing system may train (e.g., re-train) the at least one MLM in accordance with the at least one performance indicator metric. For example, optional step 380 may include labeling at least one training data vector in accordance with the at least one performance indicator metric, where the at least one MLM is trained in accordance with the at least one training data vector. For instance, the at least one training data vector may comprise at least one performance indicator metric associated with a utilization of the open cellular network by the at least the first endpoint device and a label based upon the at least one performance indicator metric associated with the data connection between the at least the first endpoint device and the private cellular network.

Following step 340 or any of optional steps 350-380, the method 300 proceeds to step 395 where the method 300 ends.

It should be noted that the method 300 may be expanded to include additional steps or may be modified to include additional operations with respect to the steps outlined above. For example, the method 300 may be repeated on an ongoing basis to perform steps 310-340, steps 310-360, etc. for other endpoint devices at subsequent times, steps 370-380, to continue to collect observations from the PCN for data labeling and MLM training, and so forth. In one example, the endpoint device(s) may report the performance via the PCN directly to the MNO. However, this could be after the endpoint device(s) attach to the MNO, which may still be useful for SLA compliance determination and model training (e.g., data labeling for model training, e.g., to see how the PCN performance compares to what is expected or forecast, e.g., SLA compliant/not SLA compliant, or the like). In one example, the method 300 may be expanded or modified to include steps, functions, and/or operations, or other features described in connection with the example(s) of FIGS. 1, 2, and/or 4, or as described elsewhere herein. Thus, these and other modifications are all contemplated within the scope of the present disclosure.

FIG. 4 illustrates a flowchart of an example method 400 for generating an admission control decision for at least a first endpoint device from an open cellular network via at least one machine learning model implemented by a processing system of a private cellular network based upon at least one demand forecast associated with at least one endpoint device, in accordance with the present disclosure. In one example, steps, functions and/or operations of the method 400 may be performed by one or more component of FIGS. 1 and/or 2, e.g., RIC 184, near-RT RIC 221 and non-RT RIC 222, etc., or one or more of such components in conjunction with one or more other components, such as one or more base stations, BBUs, CUs, DUs, a NWDAF, an IWF, etc. In one example, the steps, functions, or operations of method 400 may be performed by a computing device or system 500, and/or a processing system 502 as described in connection with FIG. 5 below. For instance, the computing device or system 500 may represent at least a portion of device or system deployed in a cellular network that is configured to perform the steps, functions and/or operations of the method 400. Similarly, in one example, the steps, functions, or operations of method 400 may be performed by a processing system comprising one or more computing devices collectively configured to perform various steps, functions, and/or operations of the method 400. For instance, multiple instances of the computing device or processing system 500 may collectively function as a processing system. For illustrative purposes, the method 400 is described in greater detail below in connection with an example performed by a processing system, such as processing system 502. The method 400 begins in step 405 and proceeds to step 410.

At step 410, a processing system of a private cellular network obtains a handover request for at least a first endpoint device from an open cellular network,where the handover request includes at least a first performance indicator metric associated with the open cellular network. In one example, the handover request may be transmitted by the open cellular network as described in connection with step 340 of the example method 300 of FIG. 3. For instance, it should be noted that the at least the first performance indicator metric may comprise one or more performance indicator measurements associated with the open cellular network. For example, the at least one performance indicator measurement may be associated with the at least the first endpoint device, but could be associated with other endpoint devices besides the at least the first endpoint device. This can be a data utilization, or throughput, applications used/data traffic types, a call volume, a text volume, an overall data volume, etc. To further illustrate, the at least one performance indicator measurement associated with the open cellular network may include a measure of a data throughput associated with the at least the first endpoint device, an endpoint device demand grouping associated with the at least the first endpoint device (e.g., customer segment, such as low usage, medium usage, heavy usage, etc.), or the like. It should be noted that the metrics may be currently observed metrics and/or historical metrics, or forecast (future) metrics. Alternatively, or in addition, the at least the first performance indicator metric may comprise at least one QoS preference associated with the at least the first endpoint device. For example, the at least one QoS preference may include at least one of: a minimum requested throughput or a maximum requested latency. For instance, the QoS preference(s) may be endpoint device-specific within permitted ranges as defined by a SLA.

In one example, the at least the first performance indicator metric may comprise at least one demand forecast associated with the at least the first endpoint device. In one example, the at least one demand forecast may include at least one of: a forecast throughput demand, a forecast call volume, a forecast call duration for one or more calls, a forecast session duration, a forecast mobility metric, or the like (e.g., associated with one or more of the at least one endpoint device). It should be noted that the mobility metric may be indicative of how much movement to expect of the at least one endpoint device (e.g., within the coverage area of the PCN and/or in general and/or during an anticipated time period in which the at least one endpoint device will be within the coverage area of the PCN, and so forth).

At step 420, the processing system generates an admission control decision via at least one machine learning model (MLM) that is implemented by the processing system based upon at least one demand forecast associated with at least one endpoint device. In one example, the admission control decision may be based on a load prediction for one or more cell sites of the PCN (e.g., a cell load prediction) and/or a QoS forecast (e.g., what does the PCN expect that it can provide given the demand). In one example, the at least one MLM may comprise at least a first MLM that is configured to generate an output comprising the admission control decision in response to an input vector comprising the at least one demand forecast associated with the at least one endpoint device. In one example, the input vector may further include: at least one network load metric associated with the private cellular network and/or a volume of handover requests from the open cellular network (e.g., within a recent time period, such as the last 30 minutes or the like). In one example, the input vector may further include one or more SLA conditions. However, in another example, the SLA conditions may be accounted for as part of the objective condition(s) of the MLM training.

In one example, the at least the first MLM may be trained in accordance with a training data set to maximize a reward associated with a SLA between the PCN and the open cellular network. For instance, the at least the first MLM may comprise or may be a component of a user admission control, or user access control (UAC) xApp. In addition, in such an example, labels for training data vectors in the training data set may indicate whether SLA was complied with or not. Alternatively, or in addition, the at least the first MLM may be trained in accordance with the training data set to minimize a penalty associated with the SLA between the PCN and the open cellular network. To further illustrate, labels for training vectors in the training data set can indicate whether SLA was complied with or not in terms of throughput, packet loss, call drop rate, call block rate, etc. for the individual endpoint devices being served or collectively over a time period for a plurality of endpoint devices.

In one example, the at least one MLM may further comprise: at least a second MLM that is configured to generate an output comprising the at least one demand forecast associated with the at least one endpoint device and/or at least a third MLM that is configured to generate an output comprising at least one load prediction of the PCN, where the input vector comprises the at least one demand forecast associated with the at least one endpoint device and the at least one load prediction of the PCN. For instance, the at least one load condition may be traffic volume, congestion level, demand/demand forecasts, QoS provided to endpoint devices, number of endpoint devices served, a call block rate, a call failure rate, etc. In one example, different MLMs may be trained and deployed for prediction associated with different ones of the foregoing types of load conditions.

In one example, the at least the second MLM may be configured to generate the output comprising the at least one demand forecast associated with the at least one endpoint device in response to a second input vector. For instance, the second input vector may include one or more of: a location of the at least one endpoint device, a device type of the at least one endpoint device, a time-of-day, a day-of-week, an application utilization of the at least one endpoint device, a handover history of the at least one endpoint device, or the like. For instance, in such an example, the at least the second MLM may comprise or may be a component of an admitted user behavior prediction (AUBP) rApp. In one example, the at least the second machine learning model is trained in accordance with a training data set to maximize an accuracy of predicted demand forecasts. To further illustrate, a training data set for the at least the second MLM can include records of input features from time periods prior to an admission control decision, where the labels can be the actual observed demand (e.g., quantified as resource usage, session duration, and/or a difference between the predicted and actual mobility patterns/metrics, etc.). In one example, the output of the second MLM may alternatively or additionally include a forecast mobility pattern and/or a forecast QoS. In one example, the at least the first MLM may be instantiated as a rApp, and the at least the second MLM may be instantiated as an xApp.

At step 440, the processing system establishes a data connection between the at least the first endpoint device and the PCN in accordance with the admission control decision (i.e., where the admission control decision is to allow the at least the first endpoint device to attach to the PCN). For instance, the at least the first endpoint device may attach to at least one cell site/base station of the PCN as designated in the admission control decision transmitted to the open cellular network. For instance, the open cellular network may forward PCN access information to the at least the first endpoint device via one or more open sessions between the at least the first endpoint device and the open cellular network prior to offloading to the PCN (e.g., where the offloading may be completed when step 440 is completed and the at least the first endpoint device and/or the open cellular network closes the prior data connections).

At optional step 450, the processing system may forward data traffic for the at least the first endpoint device via the data connection. For instance, the processing system may receive uplink data from the at least the first endpoint device and may forward such data to one or more packet data networks (e.g., the Internet in general), to one or more other cellular endpoint devices via PCN, via PCN and the open cellular network and/or other MNOs, etc.

At optional step 460, the processing system may transmit, to the open cellular network, at least one performance indicator measurement associated with the data connection between the at least the first endpoint device and the PCN. For instance, the at least the one performance indicator measurement associated with the data connection between the at least the first endpoint device and the private cellular network may include a throughput for the at least the first endpoint device via the data connection, an uplink received signal strength indicator, a jitter measurement for the at least the first endpoint device via the data connection, and/or a quality of service measure, etc. It should be noted that each of these measurements may comprise average measures over a time period, a sequence of instantaneous metrics or samples, etc.

At optional step 470, the processing system may obtain, from the at least the first endpoint device, at least one network condition of the PCN and/or at least one network condition of the open cellular network. For example, when the at least the first endpoint device is attached to the PCN, the at least the first endpoint device may report KPIs from either or both of the PCN and the open cellular network to the PCN. It should be noted that even though the at least the first endpoint device may not be attached to the open cellular network, the at least the first endpoint device may detect signals from the open cellular network and may report measurements to the PCN.

At optional step 480, the processing system may generate a handover decision for ending the data connection between the at least the first endpoint device and the private cellular network. In one example, the handover decision may be generated via at least one additional MLM that is implemented by the processing system based upon at least one network condition of the private cellular network. For instance, the at least one network condition may be a loading condition of a cell, sector, etc., may be based upon the QoS, throughput, or other metrics being provided to the at least one endpoint device (e.g., some metrics may be non-specific with respect to a particular endpoint device, but could be a load of a sector, a cell, a cluster of cells, the PCN overall, etc., while other metrics may be specific to a particular endpoint device or group/set of endpoint devices), and so forth. In one example, the handover decision may be generated via the at least one additional MLM based upon the at least one network condition of the private cellular network and/or the at least one network condition of the open cellular network that may be obtained at optional step 470. In one example, the handover decision may also be based on availability of the open cellular network to take the at least one endpoint device back. This can be a precondition prior to utilizing the additional MLM, or a post-condition following the generating of the handover decision/output of the MLM of optional step 480. In another example, this can be an additional input factor, where the additional MLM may be highly unlikely to send the at least one endpoint device back to the open cellular network if it is unavailable or unable to take the at least one endpoint device back.

Following step 440 or any of optional steps 450-480, the method 400 proceeds to step 495 where the method 400 ends.

It should be noted that the method 400 may be expanded to include additional steps or may be modified to include additional operations with respect to the steps outlined above. For example, the method 400 may be repeated on an ongoing basis to perform steps 410-440, steps 410-450, etc. for other endpoint devices at subsequent times, steps 470-480 to continue to make decisions to return endpoint devices to the open cellular network, and so forth. In one example, the method 400 may be expanded or modified to include steps, functions, and/or operations, or other features described in connection with the example(s) of FIGS. 1-3, or as described elsewhere herein. Thus, these and other modifications are all contemplated within the scope of the present disclosure.

In addition, although not specifically specified, one or more steps, functions, or operations of the example method 300 or the example method 400 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIGS. 3 or 4 that recite a determining operation or involve a decision do not necessarily requirethat both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 5 depicts a high-level block diagram of a computing device or processing system specifically programmed to perform the functions described herein. For example, any one or more components or devices illustrated in FIGS. 1 or 2, or described in connection with the example method 300 of FIG. 3 or the example method 400 of FIG. 4 may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for generating a handover decision for offloading at least a first endpoint device to a private cellular network via at least one machine learning model implemented by a processing system of an open cellular network based upon at least one demand forecast associated with at least one endpoint device and/or for generating an admission control decision for at least a first endpoint device from an open cellular network via at least one machine learning model implemented by a processing system of a private cellular network based upon at least one demand forecast associated with at least one endpoint device, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 506 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for generating a handover decision for offloading at least a first endpoint device to a private cellular network via at least one machine learning model implemented by a processing system of an open cellular network based upon at least one demand forecast associated with at least one endpoint device and/or for generating an admission control decision for at least a first endpoint device from an open cellular network via at least one machine learning model implemented by a processing system of a private cellular network based upon at least one demand forecast associated with at least one endpoint device (e.g., a software program comprising computer-executable instructions) can be loaded into memory 504 and executed by hardware processor element 502 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for generating a handover decision for offloading at least a first endpoint device to a private cellular network via at least one machine learning model implemented by a processing system of an open cellular network based upon at least one demand forecast associated with at least one endpoint device and/or for generating an admission control decision for at least a first endpoint device from an open cellular network via at least one machine learning model implemented by a processing system of a private cellular network based upon at least one demand forecast associated with at least one endpoint device (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor of a private cellular network, a handover request for at least a first endpoint device from an open cellular network, wherein the handover request includes at least a first performance indicator metric associated with the open cellular network;
generating, by the processing system, an admission control decision via at least one machine learning model that is implemented by the processing system based upon at least one demand forecast associated with at least one endpoint device;
transmitting, by the processing system to the open cellular network, the admission control decision; and
establishing, by the processing system, a data connection between the at least the first endpoint device and the private cellular network in accordance with the admission control decision.

2. The method of claim 1, wherein the at least the first performance indicator metric comprises at least one of:
at least one performance indicator measurement associated with the open cellular network; or
at least one quality of service preference associated with the at least the first endpoint device.

3. The method of claim 2, wherein the at least one performance indicator measurement associated with the open cellular network comprises at least one of:
a measure of a data throughput associated with the at least the first endpoint device; or
an endpoint device demand grouping associated with the at least the first endpoint device.

4. The method of claim 2, wherein the at least one quality of service preference associated with the at least the first endpoint device comprises at least one of:
a minimum requested throughput; or
a maximum requested latency.

5. The method of claim 1, wherein the at least the first performance indicator metric comprises the at least one demand forecast, wherein the at least one endpoint device comprises the at least the first endpoint device.

6. The method of claim 5, wherein the at least one demand forecast comprises at least one of:
a forecast throughput demand;
a forecast call volume;
a forecast call duration for one or more calls;
a forecast session duration; or
a forecast mobility metric.

7. The method of claim 1, further comprising:
forwarding, by the processing system, data traffic for the at least the first endpoint device via the data connection.

8. The method of claim 1, further comprising:
transmitting, by the processing system to the open cellular network, at least one performance indicator measurement associated with the data connection between the at least the first endpoint device and the private cellular network.

9. The method of claim 8, wherein the at least the one performance indicator measurement associated with the data connection between the at least the first endpoint device and the private cellular network comprises at least one of:
a throughput for the at least the first endpoint device via the data connection;
an uplink received signal strength indicator;
a jitter measurement for the at least the first endpoint device via the data connection; or
a quality of service measure.

10. The method of claim 1, wherein the at least one machine learning model comprises:
at least a first machine learning model that is configured to generate an output comprising the admission control decision in response to an input vector comprising the at least one demand forecast associated with the at least one endpoint device.

11. The method of claim 10, wherein the input vector further comprises at least one of:
at least one network load metric associated with the private cellular network; or
a volume of handover requests from the open cellular network.

12. The method of claim 10, wherein the at least the first machine learning model is trained in accordance with a training data set to maximize a reward associated with a service level agreement between the private cellular network and the open cellular network.

13. The method of claim 10, wherein the at least the first machine learning model is trained in accordance with a training data set to minimize a penalty associated with a service level agreement between the private cellular network and the open cellular network.

14. The method of claim 10, wherein the at least one machine learning model further comprises at least one of:
at least a second machine learning model that is configured to generate an output comprising the at least one demand forecast associated with the at least one endpoint device; or
at least a third machine learning model that is configured to generate an output comprising at least one load prediction of the private cellular network, wherein the input vector comprises the at least one demand forecast associated with the at least one endpoint device and the at least one load prediction of the private cellular network.

15. The method of claim 14, wherein the at least the second machine learning model is configured to generate the output comprising the at least one demand forecast associated with the at least one endpoint device in response to a second input vector, the second input vector comprising at least one of:
a location of the at least one endpoint device;
a device type of the at least one endpoint device;
a time-of-day;
a day-of-week;
an application utilization of the at least one endpoint device; or
a handover history of the at least one endpoint device.

16. The method of claim 15, wherein the at least the second machine learning model is trained in accordance with a training data set to maximize an accuracy of predicted demand forecasts.

17. The method of claim 14, wherein the at least the first machine learning model is instantiated as a rapp, and wherein the at least the second machine learning model is instantiated as an xapp.

18. The method of claim 1, further comprising:
generating, by the processing system, a handover decision for ending the data connection between the at least the first endpoint device and the private cellular network, wherein the handover decision is via at least one additional machine learning model that is implemented by the processing system based upon at least one network condition of the private cellular network.

19. A non-transitory computer-readable medium storing instructions which, when executed by a processing system including at least one processor deployed in a private cellular network, cause the processing system to perform operations, the operations comprising:
obtaining a handover request for at least a first endpoint device from an open cellular network, wherein the handover request includes at least a first performance indicator metric associated with the open cellular network;
generating an admission control decision via at least one machine learning model that is implemented by the processing system based upon at least one demand forecast associated with at least one endpoint device;
transmitting, to the open cellular network, the admission control decision; and
establishing a data connection between the at least the first endpoint device and the private cellular network in accordance with the admission control decision.

20. An apparatus comprising:
a processing system including at least one processor; and
a non-transitory computer-readable medium storing instructions which, when executed by the processing system when deployed in a private cellular network, cause the processing system to perform operations, the operations comprising:
obtaining a handover request for at least a first endpoint device from an open cellular network, wherein the handover request includes at least a first performance indicator metric associated with the open cellular network;
generating an admission control decision via at least one machine learning model that is implemented by the processing system based upon at least one demand forecast associated with at least one endpoint device;
transmitting, to the open cellular network, the admission control decision; and
establishing a data connection between the at least the first endpoint device and the private cellular network in accordance with the admission control decision.
